(19) United States
(12) Patent Application Publication
(10) Pub. No.: US 2016/0080863 A1
(43) Pub. Date: Mar. 17, 2016

(54) FEEDBACK SUPPRESSION TEST FILTER CORRELATION

(71) Applicant: HARMAN INTERNATIONAL INDUSTRIES, INC., Stamford, CT (US)

(72) Inventors: Glen RUTLEDGE, Brentwood Bay (CA); Trent ROLF, South Jordan, UT (US); Brandon GRAHAM, Cottonwood Heights, UT (US)

(21) Appl. No.: 14/488,731

(22) Filed: Sep. 17, 2014

(51) Int. Cl. H04R 3/02

(52) U.S. Cl. CPC H04R 3/02

(57) ABSTRACT

A feedback suppression system for detecting a feedback peak may include a controller configured to identity at least one peak of an audio input signal that includes audio data and acoustic feedback, apply at least one signature to the at least one peak, determine a response of the at least one peak to the at least one signature, identify the at least one peak as a feedback peak in response to the determined response, and set a notch filter at the identified frequency to eliminate the acoustic feedback of the audio input signal.

### TECHNICAL FIELD

Disclosed herein is a feedback suppression test filter correlation system.

### BACKGROUND

A microphone may receive an audio signal and transmit the same to an amplifier to amplify the received audio signals. Any number of loudspeakers may be used to playback the amplified audio signal. The amplified audio signal may often be subject to acoustic feedback due to a loop gain created from a closed loop established by the loudspeaker, the microphone and the amplifier.

Feedback suppression systems are often placed between the microphone and the amplifier to help mitigate the effects of feedback. These suppression systems may analyze an audio signal to detect feedback peaks.

### SUMMARY

A feedback suppression system for detecting a feedback peak may include a controller configured to identity at least one peak of an audio input signal that includes audio data and acoustic feedback, apply at least one signature to the at least one peak, determine a response of the at least one peak to the at least one signature, identify the at least one peak as a feedback peak in response to the determined response, and set a notch filter at the identified frequency to eliminate the acoustic feedback of the audio input signal.

A feedback suppression system for detecting a feedback peak may include a controller programmed to identity at least one peak of an audio input signal that includes audio data and acoustic feedback, measure at least one feature of the at least one peak, determine a signature test classifier of the peak in response to the at least one feature, select a signature test based on the classifier, applying the signature test to the at least one peak, and identify the at least one peak as a feedback peak in response to the selected signature test.

A feedback suppression system may include a controller configured to identity at least one peak of an audio input signal that includes audio data and acoustic feedback, apply at least one notch filter to the at least one peak, recognize a change in a slope of the at least one peak in response to the notch filter, compare the slope to a slope threshold, and adjust a gain of the notch filter in response to the slope threshold exceeding the slope.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 is a block diagram of a sound system in accordance to one embodiment;

FIGS. 2a and 2b are block diagrams of a digital processor of FIG. 1 in accordance to one embodiment;

FIG. 3 is a process flow diagram illustrating the signal processing performed by the processor;

FIG. 4 is a process flow diagram for analyzing and processing digital samples within the processor in accordance to one embodiment;

FIG. 5 is a block diagram for a process of an assignment system of the sound system in accordance to one embodiment;

FIG. 6 is a block diagram illustrating the various states of a state machine of the sound system in accordance to one embodiment;

FIGS. 7A-B illustrate filter gain and peak magnitude over time;

FIGS. 8A-C illustrate filter gain, peak magnitude and slope over time; and

FIG. 9 is a block diagram for a process for testing a feedback candidate peak.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a frequency estimation system to be used with a feedback suppression system. The frequency estimation system estimates the frequencies at which feedback peaks occur. A notch filter is then placed at these frequencies to reduce the gain and thus reduce feedback. The estimated frequency may be determined using a phase spectrum of a Fast Fourier Transform (FFT) analysis of the audio signal in conjunction with the magnitude spectrum. The disclosed system provides for an improved system for distinguishing between true feedback peaks and other peaks caused by program content.

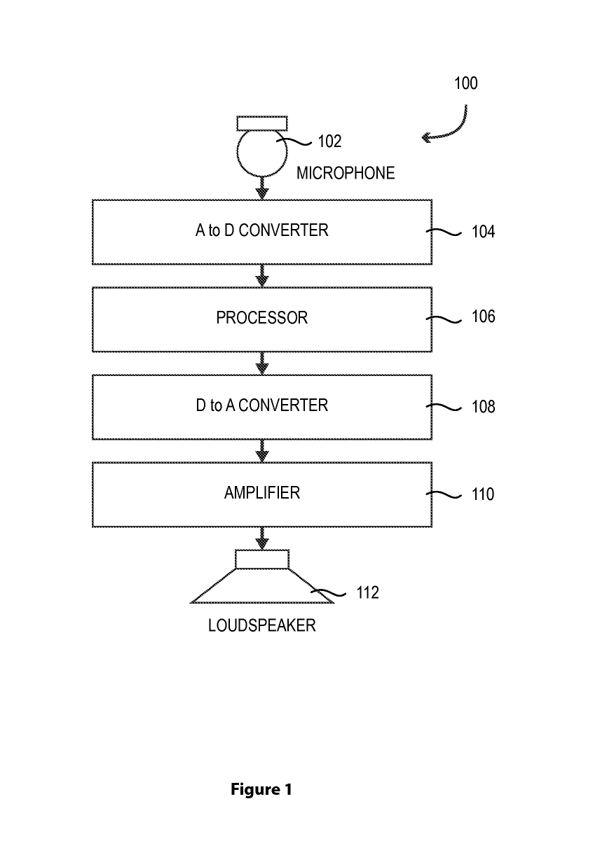

FIG. 1 is a sound system 100 for suppressing feedback via phase enhanced frequency estimation. The system 100 includes at least one microphone 102, an analog-to-digital converter (ADC) 104, a processor 106, a digital-to-analog converter (DAC) 108 and an amplifier 110. The microphone 102 receives an audio input and may generate electrical signals indicative of the audio input based on sounds produced nearby. The ADC 104 may sample the electrical signals from the microphone 102 at a given rate (e.g., every 21 microseconds). The ADC 104 may convert the sampled signals from the microphone 102 into digital samples. The processor 106 receives the digital samples and processes the same to remove any feedback from the digital samples. For example, the processor 106 may include a notch filter that may reject or attenuate a frequency band between a lower frequency band and a higher frequency band. The processor 106 may then transmit the processed samples to the DAC 108, which in turn may create analog electrical signals. The analog electrical signals are then sent to the amplifier 110 which drives the loudspeaker 112 to create acoustic signals that are free of feedback.

The processor 106 may be a hardware based computing device or may be within a computing device. The processor 106 may include a controller including computer-executable instructions, where the instructions may be executable by one or more computing devices.

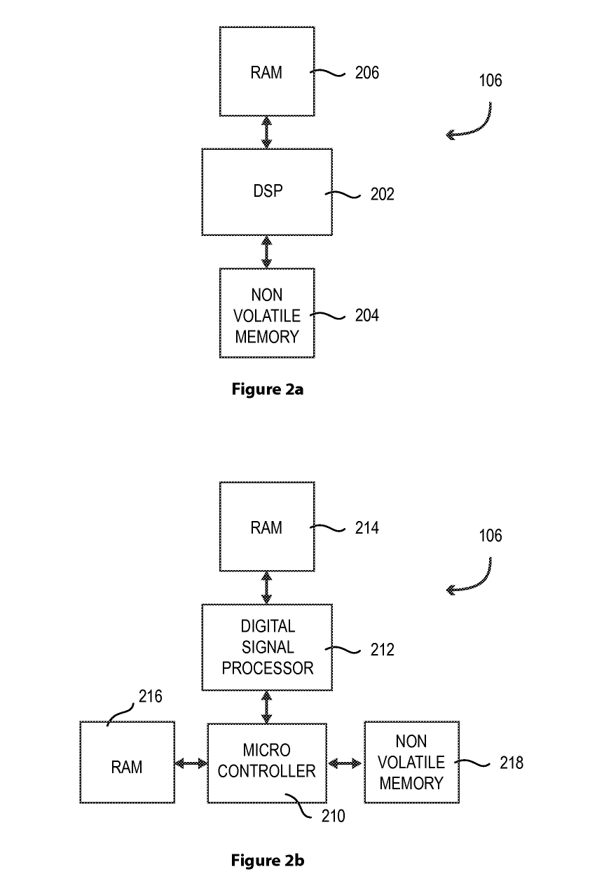

FIGS. 2a and 2b are block diagrams of the processor 106 of FIG. 1. In the example shown in FIG. 2a, the processor 106 may include a digital signal processor (DSP) 202, a non-volatile memory 204 for storing program instructions and a random access memory (RAM) 206 for storing digital samples received from the ADC 104. In the example shown in FIG. 2b, the processor 106 may include, or be in communication with, a separate microprocessor, for example, a loudspeaker controller 210. In this example, the processor 106 may include a DSP 212 having its own RAM 214 and the controller 210. Such an arrangement allows for sharing of resources and functions. The controller 210 may be coupled to another RAM 216 and a non-volatile memory 218.

The RAMs 206, 214, 216 may be memory devices to store data items capable and enable such data items to be read therefrom. The RAMs 206, 214, 216 may include circular buffers. The non-volatile memories 204, 218 may store program instructions and may be in the form of flash memory or read only memory (ROM). The program instructions may be loaded during a start-up process in the appropriate RAM 206, 214, 216.

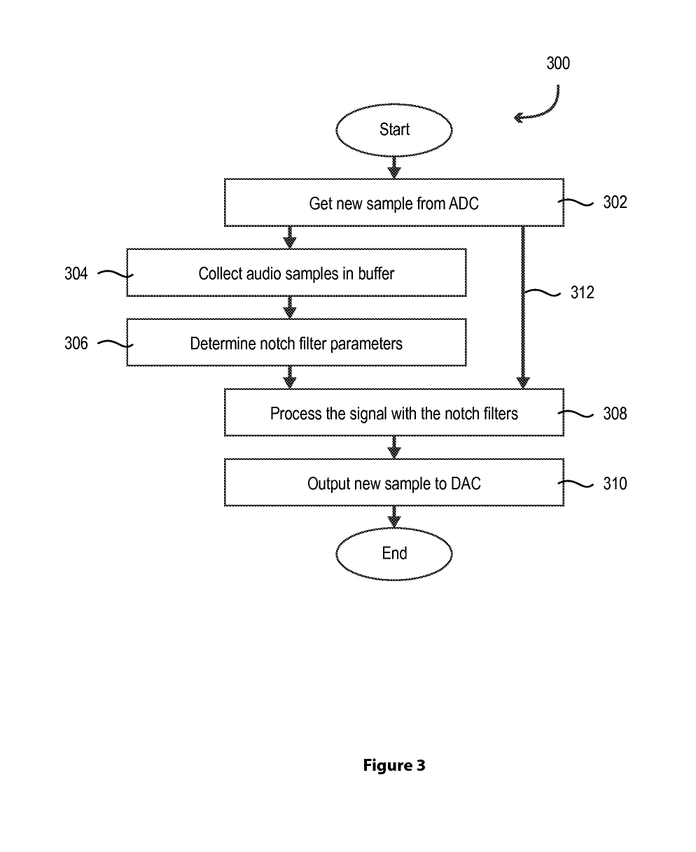

FIG. 3 is a process 300 illustrating the manner in which the processor 106 processes signals according to one embodiment. At block 302, the processor 106 may receive a new digital sample from the ADC 104. As explained, each signal may be received every approximately 21 microseconds from the ADC 104 and the microphone 102. A simple optimization may be performed wherein the samples are buffered from the ADC 104 at up into 32 sample or 64 sample frames at this stage. This optimization may be performed to increase efficiency. Once the digital sample is received, the process 300 proceeds to block 304.

At block 304, the processor 106 stores the digital samples in a buffer in RAM 206.

At block 306, the processor 106 may analyze the digital samples and determine notch filter parameters such as frequency, bandwidth or alternatively Quality factor, which is inversely related to the bandwidth (i.e., Q-value), and gain. This process may be performed at intervals, such as every 85 milliseconds.

At block 308, the processor 106 may apply at least one notch filter to the samples using the determined notch filter parameters. The samples are processed in the time domain using the filter parameters determined in block 306. While the samples may be processed at one processing rate, the notch filter parameters may be defined at a different processing rate (typically a much slower rate) at block 306, as indicated by the line 312.Advantages exist in running block 306 at a slower rate than the filtering block 308 since block 306 is computationally complex. When the notch filter parameters are changed in block 306, the filter parameters used in block 308 are slowly changed (i.e., interpolated) from their current values to the new target values defined by block 306 over a time of approximately 50-200 ms to avoid introducing clicks in the audio. The interpolation can be done on the filter parameters, on the actual computed filter coefficients, or on a combination of both.

At block 310, once the notch filter has been applied, the processed samples are sent to the DAC 108. The process 300 then ends.

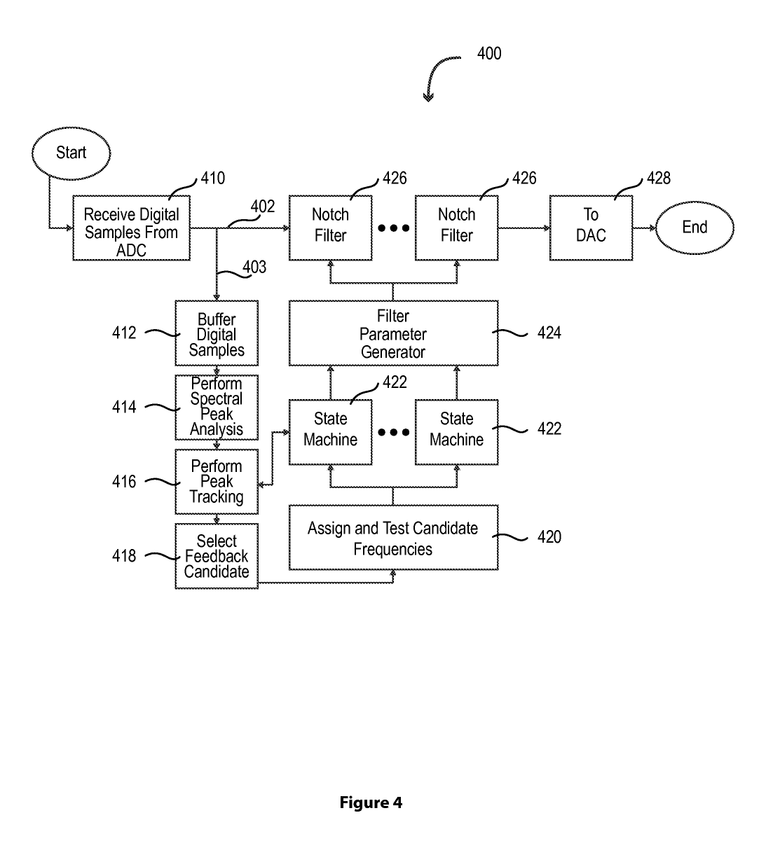

FIG. 4 is a process 400 for analyzing and processing the digital samples at the processor 106. The process 400 may include analyzing the digital samples and determining the various notch filter parameters along path 403 (e.g., block 306 in FIG. 3). The process 400 may process the digital samples by applying at least one notch filter using the determined notch filter parameters along path 402 (e.g., block 308 in FIG. 3).

At block 410, the processor 106 may receive the digital samples from the ADC.

At block 412, along path 403, the processor 106 may transmit the stored copies of the digital signals to a buffer (in RAM206). The notch filter parameters determined along path 403, may be determined at one rate while the digitals samples may be processed along path 402 at a different rate. That is, the stored copies of the digital signals may be used to generate the notch filter parameters at a different rate than the rate at which the digital signals are processed. In one example, the notch filter parameters may be determined at a rate of once every 85 milliseconds while the digital signals may be processed at a rate of once every 21 microseconds.

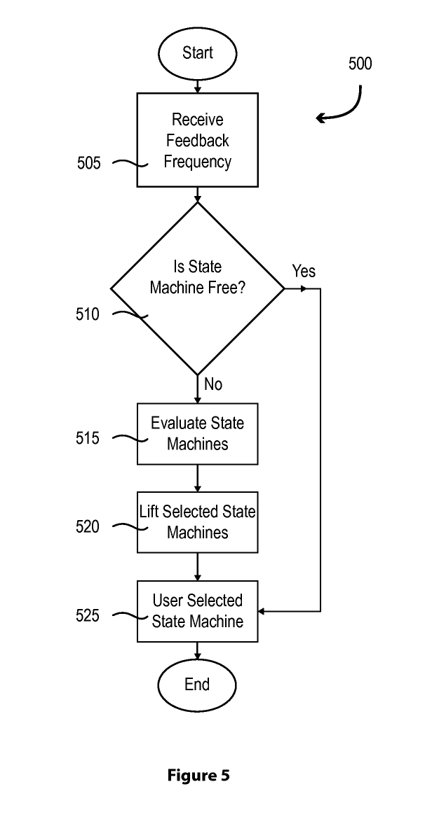

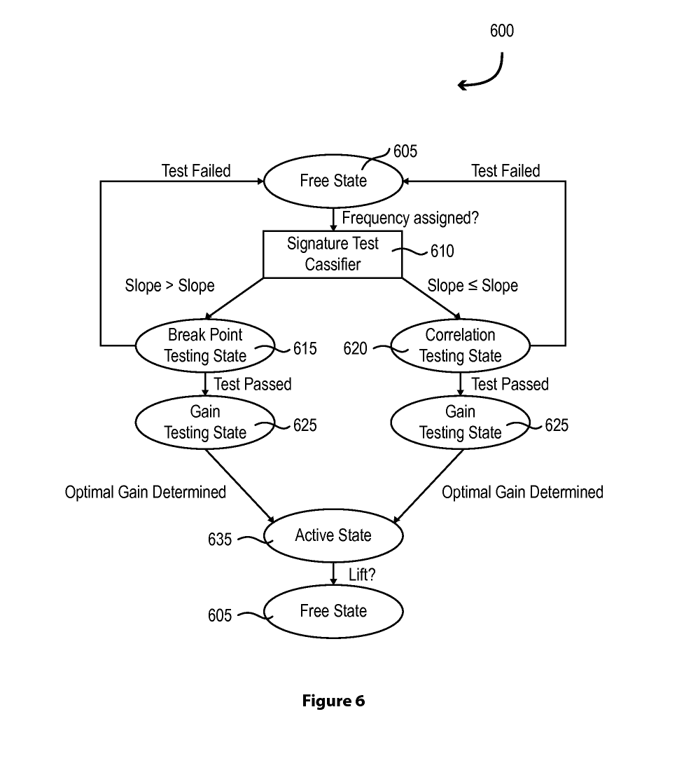

At block 414, the processor 106 may perform a spectral analysis of the buffered signals to isolate peaks in the magnitude spectrum. During this process, frequency estimates as well as other spectral features such as the average spectral level may be used to isolate the peaks. This process is described in more detail with respect to FIGS. 5 and 6 below.

At block 416, the processor 106 may perform a spectral peak analysis to identify a peak trajectory based on a tracking of the peaks over a time period. Several peak features may be extracted from the peak trajectory, such as the rate of growth of the peak magnitudes, the standard deviations of the peak magnitudes, the rate of change of the peak frequencies, and the standard deviations of the peak frequencies. Other measures of deviation could also be used here such as maximum absolute deviation.

At block 418, the processor 106 may use the extracted features for each peak trajectory to classify each peak as either a feedback peak or a program material peak. The classifier can be based on simple thresholds for each of the extracted features or it can use more advanced techniques such as a Bayesian classifier or a neural network. The parameters of the classifier may either be tuned by hand or they may be estimated by using a training set of peaks that are pre-classified as feedback peaks or program material peaks. The deviation in frequency of the classified peak is a useful feature when the frequency is estimated using fast frequency reassignment. This may be due, at least in part, to the very small measurement error associated with fast frequency reassignment (see, e.g., equation 14 below) that allows the natural deviation of the peaks to be accurately estimated. Feedback peaks tend to have very small deviation where most program material peaks from voices or instruments tend to have significantly larger deviation. Thus the deviation in the reassigned frequency of the peak trajectories is a powerful discriminant for classifying peaks as either program material or feedback. For example, the deviation in frequency can be computed as:

$$dF ( {k}_{peak} ) = \frac{1}{N} {\sum }_{k = 0}^{N - 1} abs ( F ( {k}_{peak} , k ) - F ( ) ) \qquad Eq . 1$$

where kₚₑₐₖ is the index of the kth peak, F(kₚₑₐₖ, k) is the reassigned frequency of the k^{th} peak at a delay of k measurement intervals, and F( [symbol] ) is the mean value of the reassigned frequency over the past N measurement intervals. The absolute value is taken of the difference of F(kₚₑₐₖ, k)−F( [symbol] ). A measurement interval k may refer to each time the reassigned frequency is computed for a peak (typically every 85 ms). Most feedback peaks will have a dF(kₚₑₐₖ) of <1 cent whereas peaks from real program material will have a _{dF}(kₚₑₐₖ) of 5 cents or more (1 cent is 1/100 of a semitone), which emphasizes why dF(kₚₑₐₖ) is an excellent feature for classifying peaks into feedback or program material groups.

If the peak trajectory is determined to be a feedback peak, then the frequency of the respective peak may be determined to be a candidate peak and may be transmitted to block 420, as described below.

It should be noted that each of the processes in blocks 416 and 418 may include a series of routines or sub-processes. Further, the path 402 may be referred to as an implementation process. Once the notch filter parameters are determined (e.g., blocks 412-418 along path 403), the implementation process (e.g., blocks 420-424) may test candidate frequencies received from block 418 by applying a corresponding notch filter at the candidate peak to the digital signal.

At block 420, the processor 106 may receive the candidate frequencies and assign a state machine subroutine to each candidate peak. The processor 106 may assign the candidate frequencies based on a control scheme that runs the state matching subroutines in succession from zero to the last state machine routine. There may be N number of machines for N number of notch filters wherein one state machine may control one notch filter. For each candidate peak, the assignment process 420 searches all state machine routines (blocks 422). If the candidate peak frequency is close to a frequency that has already been assigned to a state machine (e.g., is already in use), the candidate peak is assigned to that same state machine routine. In this case, the notch filter frequency associated with the state machine may be adjusted to the average of its current frequency and the new frequency. In addition the gain of its notch filter may be adjusted by a nominal amount (typically −3 to −6 dB) up to a maximum attenuation (typically −18 dB) and the bandwidth may be increased by an amount proportional to the difference between the state machines current notch frequency and the new candidate peak frequency so the filter can more easily cover the two feedback peaks. If the candidate peak frequency is not close to any existing state machine notch frequencies, then the candidate peak is assigned to the first free state machine routine with a nominal gain (typically −6 dB) and bandwidth (typical Q of 10-120). If there are no free state machines, then the oldest state machine (i.e., the state machine that was assigned a frequency earlier than any of the others) is used and the new candidate peak is assigned to it with a nominal gain (typically −6 dB) and bandwidth (typical Q of 10-120).

At block 424, the filter parameters including frequency, gain and bandwidth (or Q-value), are converted into filter coefficients using a standard notch filter design, where each notch filter is implemented with a single biquadratic filter, or biquad.

At blocks 426, the processor 106 applies the notch filters using the generated filter coefficients from block 424. That is, the notch filter is applied at the estimated frequency from block 414, or in the case where one state machine shares multiple candidate frequencies, the notch filter is applied at a frequency derived from the individual candidate frequencies derived in block 414.

At block 428, the processor 106 transmits the filtered digital samples to the DAC 108 for conversion back to the analog domain (e.g., analog electrical signals). The process 400 may end. The resultant analog electrical signals may ultimately be passed to the amplifier 110 and the loudspeaker 112 for reproduction.

FIG. 5 illustrates a process 500 of an assignment system of the sound system in accordance to one embodiment. The assignment system may correlate to block 420 of FIG. 4. As described above, each state machine 422 may control a notch test filter (also referred to herein as a notch filter and test filter). Each feedback candidate peak may be assigned to a state machine 422. The assignment system may determine which of the N state machines to use. Typically, there may be between approximately 10 and 30 state machines. If a free state machine 422 is available, that is, if a candidate peak has not been assigned to that machine, then the free machine may be selected. Otherwise, the assignment system must lift one of the state machines 422 to a free state so that it may be used. That is, a state machine may be cleared to process the current candidate peak.

The selection of which state machine 422 to ‘lift’ may be based on several factors, including but not limited to: (1.) which state machine has been active the longest, (2.) which state machine has the lowest gain (i.e., least attenuation), and (3.) which state machine that has recorded the lowest initial magnitude slope. One, or any combination, of these factors may be used to determine which state machine to free. Further, if a combination of these factors are used to evaluate the state machines 422, varying weights may be given to each factor. For example, more weight may be given to the third factor since it would favor lifting the state machine on the frequency candidate with the lowest initial magnitude slope. Once a state machine 422 is freed, or ‘lifted’, the next frequency candidate may be processed.

Referring again to FIG. 5, at block 505 the processor 106 may receive the feedback candidate peak. At block 510, the processor 106 may determine whether a state machine 422 is available. That is, the processor 106 may determine whether a state machine 422 is not otherwise processing another candidate peak. If the processor 106 identifies a free state machine, the process proceeds to block 525. If not, the process proceeds to block 515.

At block 515, when all of the state machines 422 processing other candidate frequencies, the processor 106 may evaluate the state machines 422 to identify which state machine to free. As explained, this may be done by using certain factors as listed above. Based on the factors, the processor 106 may assign an assignment score to each machine 422. The machine with the highest assignment score may be identified as the next free machine. For example, a machine having the lowest initial magnitude slope may have the highest score, and thus be identified as the next free machine. Once the machines 422 have been evaluated, the process may proceed to block 520.

At block 520, the processor 106 may ‘lift’ the next free machine. That is, the selected machine may be cleared and used to process the feedback candidate peak.

At block 525, the processor 106 may assign the selected state machine for the received feedback candidate peak. The process may then end.

FIG. 6 is a block diagram illustrating the various states of a state matching 422 of the sound system. These states may be filter states for processing the candidate peak at each machine 422. While ‘candidate peak’ is described herein as a single peak, it should be recognized that a plurality of candidate peaks may be processed by the state machines 422. Each candidate peak may be filtered and analyzed to determine whether the candidate peak is a feedback peak. To do this, the processor 106 may instruct each state to dynamically apply a signature test to determine if a tracked frequency peak is a feedback peak and to determine an optimal gain to use for suppressing the feedback peak. The state machine 422 may operate in one of six filter states: (1.) free state, (2.) break point testing state, (3.) correlation testing state, (4.) break point gain testing state, (5.) correlation gain testing state, and (6.) active state.

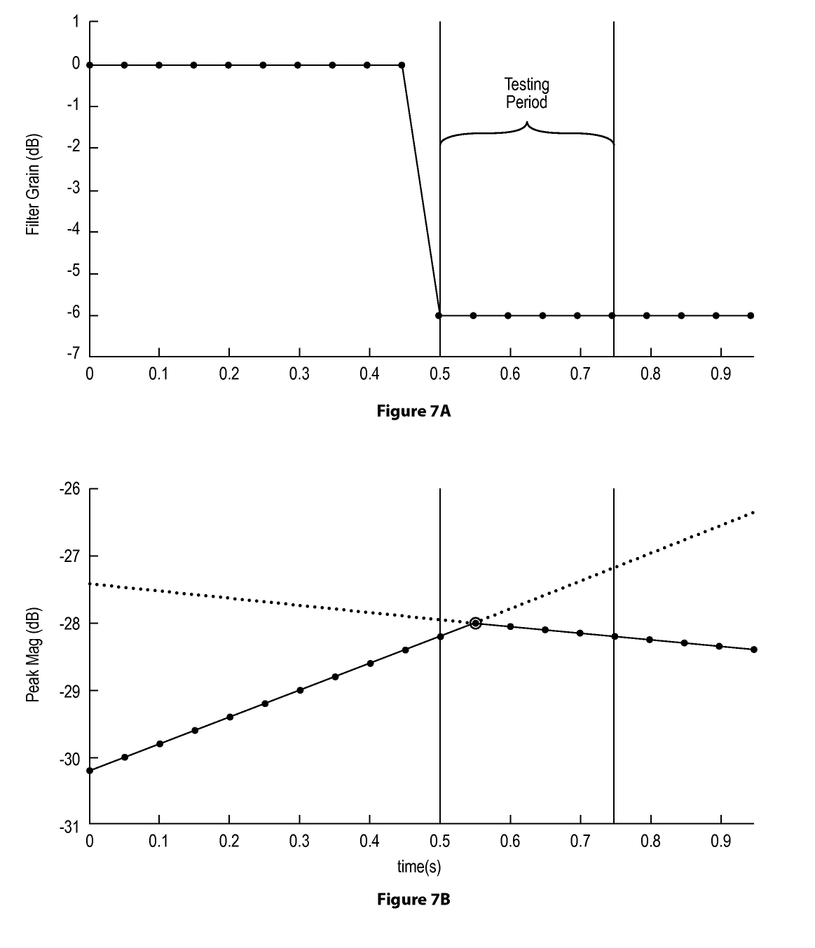

A state machine 422 that is in a free state may be free of any candidate frequencies. That is, the state machine 422 may currently be free of processing frequencies, and thus be available for an assignment thereof. Different signature tests may be applied based on features of the candidate peak. The signature test classifier may make this determination. For example, a break point testing state may indicate that break point logic is being used to test the feedback candidate peak. Similarly, the correlation testing state may indicate that correlation logic is being used to test the feedback candidate peak. In general, break point testing may be applied in response to the signal test classifier recognizing a larger slope while correlation testing may be applied in response to a smaller slope. By applying different signature tests based on certain peak features, a more accurate analysis may be performed on the candidate peak. These tests are described in more details below with respect to FIGS. 7-9. In the gain testing state, the processor 106 may determine the best gain to use for suppressing an identified feedback peak, in response to the processor 106 identifying the candidate peak as a feedback peak. The active state may indicate that the state machine is actively suppressing a feedback peak.

Thus, each state machine 422 may operate and progress through various filter states. Initially, the state machine 422 may be in the free state 605 where the state machine 422 may be awaiting an assignment of a candidate peak, as indicated in FIG. 6. Once a candidate peak has been assigned to the state machine 422, a signature test classifier may be used to determine which signature test to apply to the candidate peak. In one embodiment a magnitude of the candidate peak (i.e., the tracked peak) may be analyzed. The magnitude slope may be estimated using a least squares fit on a previous M peak dB magnitudes, with M typically chosen to cover, for example, 250 ms (e.g., 5 frames analyzed every 50 ms). Other fitting methods and durations may also be used. At block 610, if the magnitude slope is greater than a slope threshold, the state machine 422 may progress to the break point testing state 615. If the slope is less than or equal to the slope threshold, then the state machine 422 may progress to the correlation testing state 620. The slope threshold may be a predefined slope threshold such as, for example, 2 dB/s. In addition to the signature test classifier 610 determining which signature test to apply, the classifier 610 may also determine whether the candidate peak is a feedback peak without applying a signature test. That is, the classifier 610 may determine the magnitude slope of the candidate peak, and classify the peak as a feedback peak based on the determined slope.

In each of the break point testing state 615 and the correlation testing state 620, if the signature testing results in a determination that the feedback candidate is a feedback peak, then the state machine 422 progresses to the gain testing state 625.The break point testing state 615 and gain testing state 625 will be described in more detail in connection with FIGS. 7A and 7B.

FIG. 7A illustrates a filter gain in dB over time. FIG. 7B illustrates a peak magnitude over time. In the example of FIG. 7A, a constant filter gain of 0 dB (i.e. filter is off) occurs for approximately 0.5 seconds. The state machine 422 may flag the candidate peak as a potential feedback peak. A test notch filter may be placed on the peak with a −6 dB gain, or other suitable gain. Referring to FIG. 7B, the state machine 422 may evaluate the slope (i.e., the growth rate of the peak) before and during the testing period. If a change in the slope is detected, then the peak may be determined to be a feedback peak. If no change in the slope is detected during the testing period, then the peak is not a feedback peak. That is, if the tracked peak is unaffected by the notch filter, then the peak is not a feedback peak. In this example, the testing period lasts for approximately 250 ms, but shorter or longer testing periods may be used. In the example in FIG. 7B, the slope changes at, for example, approximately 0.55 seconds, indicating that the tracked peak was affected by the notch filter.

Any of number of mechanisms may be used to recognize a change in slope. In one example, a loop delay may be used, where the loop delay is the time it takes for the sound to travel from the loudspeaker 112 to the microphone 102 plus an extra delay caused from buffering as well as D/A and A/D conversions. In particular, the loop delay may be assumed to be relatively small and the slope may be measured before and after application of the notch filter using least squares, or other fitting mechanism. In the example shown, a testing period of 250 ms may be used before and after the detection time, for example, of 0.5 seconds, to measure the slope. The tracked peak may be identified as a feedback peak if the slope drops by a slope threshold (for example, 1 dB/s) and if the fit for the slopes has a standard deviation of less than a slope deviation threshold (for example, 0.2 dB). If the tracked peak is a feedback peak, the state machine 422 may progress to the gain testing state 625. If not, the test filter is removed and the state machine 422 returns to the free state 605.

In the gain testing state 625, the post-detection slope (i.e., the slope after the point of change) may be evaluated. If the post-detection slope is greater than a post-detection slope threshold, (for example, approximately −6 dB/s), then the gain of the notch filter is incremented by a predefined gain increment (for example, approximately −3 dB). The slope is then re-measured for another subsequent testing period. If the slope is less than the post-detection slope threshold, or the peak is not detected at all, then the state machine 422 progresses to the active state 635 and the gain testing state 625 is complete. If not, the process is repeated until the slope reaches the post-detection slope threshold or the peak is not detected.

The above technique provides a relatively simplistic and quick confirmation of a feedback peak. Typically, only one testing period may be necessary to confirm the feedback peak is real. However, the break point testing state 615 may erroneously identify a feedback peak if the slope coincidently changes during the time when the test filter is placed on the peak (i.e. during the testing period). This technique is best applied when the magnitude slope of the peak is above the slope threshold (e.g., 2 dB/s), since the slower but more robust correlation testing may not respond fast enough to control the feedback peak before it saturates.

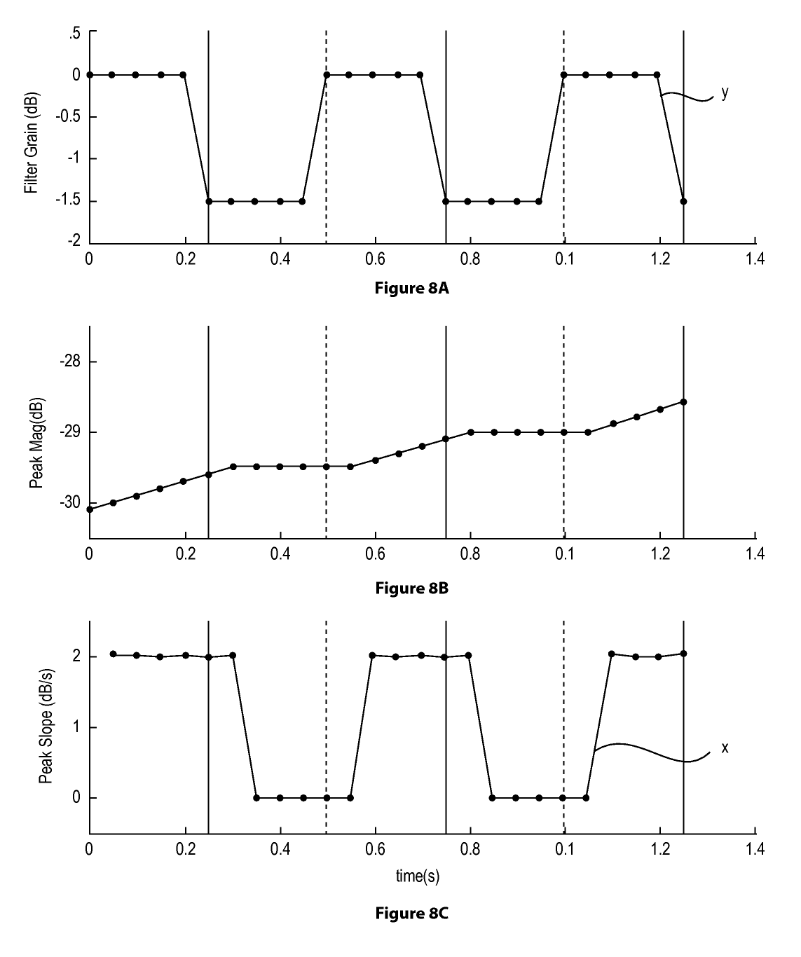

The correlation testing state 620 is described in more detail in connection with FIGS. 8A-C. In situations where the magnitude slope is less than the slope threshold (e.g., 2 dB/s), correlation detection may be used to determine whether a frequency candidate is a feedback peak.

FIG. 8A illustrates a filter gain in dB across time. As shown, the filter gain of the test filter alternates between 0 dB and −1.5 dB, approximately every 250 ms. FIG. 8B illustrates a peak magnitude over time and FIG. 8C illustrates an estimated slope over time. Small delays may occur in the slope change when switching from one gain to the other due to the loop delay. Any number of mechanisms may be used to estimate the slope of the feedback candidate. The estimated slope may indicate whether the tracked peak is a true feedback peak. If the slope of the peak magnitude modulates with the same frequency as the filter, (e.g., as the filter gain changes, so does the slope), then the tracked peak may be a feedback peak. If the estimate slope is not affected by the test filter (response is uncorrelated with changes in the test filter gain), then the tracked peak may not be a feedback peak. That is, the question as to whether a tracked peak is a feedback peak may be determined by examining the correlation between the filter changes and the magnitude slope.

Any number of mechanisms may be used to estimate the magnitude slope and evaluate the correlation between the filter gain and the slope. The slope X (plotted in FIG. 8C), may be estimated by first smoothing the peak magnitude signal (plotted in FIG. 8B), and then computing the difference from sample to sample. The filter gain Y(plotted in FIG. 8A) may then be used to correlate against X to produce a correlation C at a series of lags:

C(lag)=ΣX(k−lag)·Y(k) Eq.2

where k is the sample index which typically ranges, for example, over 1-2 seconds (at an analysis rate, for example, of 85 ms corresponds to 12-24 samples) and the lag is the delay amount which usually ranges, for example, from 0 to 400 ms (0-5 samples). A correlation coefficient CC may then be determined using:

$$CC = \frac{C ( k - max )}{\sqrt{Σ X ( {k}^{2} )} \sqrt{Σ Y ( {k}^{2} )}} \qquad Eq . 3$$

where max is the lag at which C(lag) is a maximum. Since CC is normalized by the energy in X and Y, X and Y typically do not have to be pre-scaled. However, on some processing platforms it may be necessary to pre-scale X and Y to maximize precision of the calculation. In this case, both X and Y can be scaled to range between −1 and 1.

The correlation coefficient CC may then be compared to a correlation threshold (e.g., 0.5) and classified as a feedback peak if the coefficient CC exceeds the threshold. Upon this determination, the test filter remains in place and the state machine proceeds to the Gain Testing State (625) as described in paragraph 52. If the correlation coefficient CC does not exceed the threshold, the test filter is removed and the state machine returns to the free state.

Correlation testing 620 of the tracked peak may take more time than break point testing 615, but it is very robust and can detect feedback peaks that are relatively small and growing slowly, which are typically very hard to detect in a feedback suppression system. Further, since the filter gain is lower in this test (e.g. −1.5 dB), the audio artifacts during the testing phase may be small which is a big advantage over break point testing where the filter gain is typically −6 dB.

However, since correlation testing takes a relatively long time to perform, this technique can only be used on slowly growing peaks. If the correlation gain testing was used on a larger slope (e.g., 10 dB/s), then the correlation gain testing may not react fast enough for such a rapidly increasing peak to be confirmed as a feedback peak before it saturates. For this reason, it is critical to have at least one other testing state besides correlation testing that is able to confirm feedback peaks quickly. In the current embodiment breakpoint testing is used, but other methods may also be employed, including the case where a candidate peak is considered a peak without further testing if the magnitude slope is large enough. In addition, the decision to use correlation testing or some other faster method may be based on more than just the magnitude slope of the peak. For example, it could depend on the combination of the peak magnitude and the magnitude slope, or some more complicated classification method.

Returning to FIG. 6, the state machine 422 may evaluate a tracked peak at the gain testing state 625. The state machine 422 remains in the respective gain testing state 625, until the magnitude slope of the feedback peak is reduced below a post-detection slope threshold. The post-detection threshold may be a predetermined threshold such as −6 dB/s, as explained above. Once the magnitude slope falls below the threshold, the state machine 422 may progress to the active state 630 where the feedback peak continues to be filtered. The state machine 422 may remain in the active state until the state machine filter is lifted by either the assignment system or a user control (e.g., instructions to clear all filters). The state machine 422 may also be lifted by a timer. For example, the state machine 422 may remain active for a predefined amount of time (e.g., between 2 and 3600 seconds). Once the defined time has elapsed, the filter gain may slowly be moved towards zero gain to avoid feedback from rapidly re-occurring.

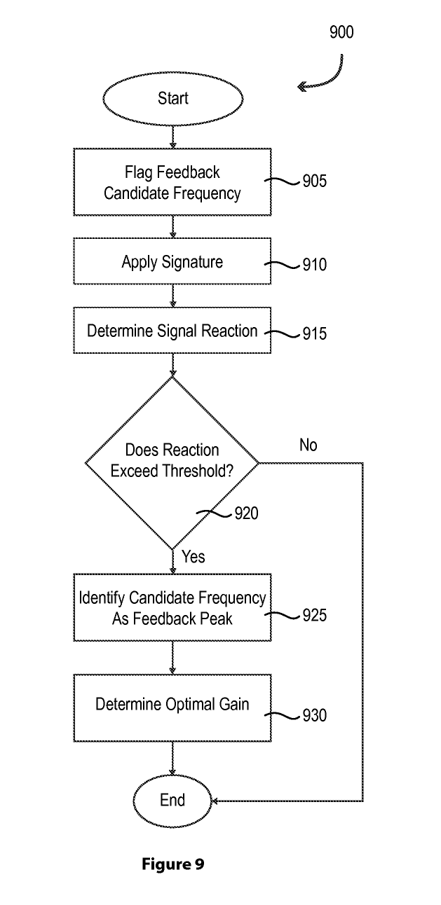

FIG. 9 illustrates a general process 900 for testing certain feedback candidate frequencies to determine whether such candidate frequencies should be confirmed as feedback peaks, in accordance with one embodiment. The process 900 begins at block 905, where a peak is flagged as a potential feedback candidate peak.

At block 910, the processor 106 may apply a signature to the candidate peak. The signature may be a test filter, or notch filter with a predefined gain, or a series of changes in the gain of the notch filter. The signature may also be a pitch shift, a frequency shift, or other signal processes or alterations that can be detected when the signal completes the feedback loop. As noted above, with respect to the break point testing state, a notch filter having a gain of −6 dB may be applied to the candidate peak. The correlation testing state may alternately apply a notch filter with a gain, for example, of 0 dB and −1.5 dB.

At block 915, the processor 106 may determine the effect of the applied signature on the candidate peak. In the examples explained above, the processor 106 may determine the change in slope of the magnitude of the candidate peak during a period when the signature is applied (i.e., the testing period.) In the case of correlation testing, the processor 106 could measure correlation between gain changes in a notch filter and slope changes in the signal.

At block 920, the processor 106 may determine whether a reaction of the peak to the applied signature exceeds a certain threshold. As explained above, the processor 106 may determine whether the change in slope exceeds a slope threshold, or the correlation coefficient between the filter gain and magnitude slope exceeds a correlation threshold. If these tests pass (that is the peak reacted to the applied signature in the expected way for a feedback peak) then the candidate peak is identified as a feedback peak 925 and the optimal gain required to suppress the feedback peak is determined at 930 and the process ends.

As explained, the processor 106 may be a computing device or within a computing device. The processor 106 may include a controller including computer-executable instructions, where the instructions may be executable by one or more computing devices. Computer-executable instructions may be compiled or interpreted from computer programs created using a variety of programming languages and/or technologies, including, without limitation, and either alone or in combination, Java™, C, C++, Visual Basic, Java Script, Perl, Matlab Simulink, TargetLink, etc. In general, a processor 106 (or a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, EEPROM (Electrically Erasable Programmable Read-Only Memory and is a type of non-volatile memory used in computers and other electronic devices to store small amounts of data that must be saved when power is removed, e.g., calibration tables or device configuration.) optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

While embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A feedback suppression system for detecting a feedback peak, comprising:
a controller configured to:
identity at least one peak of an audio input signal that includes audio data and acoustic feedback;
apply at least one signature to the at least one peak;
determine a response of the at least one peak to the at least one signature;
identify the at least one peak as a feedback peak in response to the determined response; and
set a notch filter at the identified frequency to eliminate the acoustic feedback of the audio input signal.

2. The system of claim 1, wherein the signature includes at least one test filter having a predefined gain.

3. The system of claim 1, wherein the signature includes at least one of a pitch shift and frequency shift.

4. The system of claim 1, wherein the response of the at least one peak includes a change in slope of a magnitude of the peak.

5. The system of claim 4, wherein the at least one peak is identified as a feedback peak in response to the change in slope exceeding a slope threshold.

6. The system of claim 1, wherein the response of the at least one peak includes determining a correlation coefficient between gain changes in the notch filter and slope changes in audio input signal.

7. The system of claim 6, wherein the at least one peak is identified as a feedback peak in response to the correlation coefficient exceeding a correlation threshold.

8. A feedback suppression system for detecting a feedback peak, comprising:
a controller programmed to:
identity at least one peak of an audio input signal that includes audio data and acoustic feedback;
measure at least one feature of the at least one peak;
determine a signature test classifier of the peak in response to the at least one feature;
select a signature test based on the classifier;
applying the signature test to the at least one peak; and
identify the at least one peak as a feedback peak in response to the selected signature test.

9. The system of claim 8, where the signature test classifier selects between one of two distinct signature tests.

10. The system of claim 8, wherein the signature test classifier identifies the at least one peak as a feedback peak without applying a signature test.

11. The system of claim 8, wherein the at least one feature includes a magnitude of the at least one peak.

12. The system of claim 8, wherein the signature test includes at least one of a break point test and a correlation test.

13. The system of claim 12, wherein the at least one features includes a magnitude slope of the at least one peak.

14. The system of claim 13, wherein the signature test classifier selects the break point test in response to the magnitude slope exceeding a slope threshold and wherein the signature test classifier selects the correlation test in response to the magnitude slope not exceeding the slope threshold.

15. The system of claim 14, wherein a response of the at least one peak includes a change in slope of a magnitude of the at least one peak during the break point test.

16. The system of claim 15, wherein the at least one peak is identified as a feedback peak in response to the change in slope exceeding a slope threshold.

17. The system of claim 14, wherein a response of the at least one peak includes determining a correlation coefficient between gain changes in a notch filter and slope changes in a magnitude peak during the correlation test.

18. A feedback suppression system, comprising:
a controller configured to:
identity at least one peak of an audio input signal that includes audio data and acoustic feedback;
apply at least one notch filter to the at least one peak;
recognize a change in a slope of the at least one peak in response to the notch filter;
compare the slope to a slope threshold; and
adjust a gain of the notch filter in response to the slope threshold exceeding the slope.

19. The system of claim 18, wherein the change in slope is a post-detection slope recognized at a point of change in response to the application of the notch filter.

20. The system of claiml9, wherein the notch filter is applied during a testing period and the point of change and post-detection slope are each recognized within the testing period.
